(19) United States
(12) Patent Application Publication
(10) Pub. No.: US 2025/0382418 A1
(43) Pub. Date: Dec. 18, 2025

(54) DISPLAY PANEL, ALIGNMENT FILM COMPOSITION AND DISPLAY DEVICE

(71) Applicant: Guangzhou China Star Optoelectronics Semiconductor Display Technology Co., LTd., Guangzhou (CN)

(72) Inventor: Duokai ZHAO, Guangzhou (CN)

(73) Assignee: Guangzhou China Star Optoelectronics Semiconductor Display Technology Co., LTd., Guangzhou (CN)

(21) Appl. No.: 18/778,828

(22) Filed: Jul. 19, 2024

(30) Foreign Application Priority Data
Jun. 12, 2024 (CN) 202410756962.3

(51) Int. Cl. C08G 73/10; B32B 27/28; G02F 1/1337

(52) U.S. Cl. CPC C08G 73/1085; B32B 27/281; C08G 73/1078; G02F 1/133723; B32B 2305/55; B32B 2307/7376; B32B 2457/202; C09K 2323/027

(57) ABSTRACT

A display panel, an alignment film composition and a display device are provided. The display panel includes a first substrate, a second substrate, and a first alignment layer. The first substrate is disposed opposite to the second substrate. The first alignment layer is disposed on a side of the first substrate closer to the second substrate, and the first alignment layer has a first polyimide molecular chain, and the first polyimide molecular chain comprises a unit represented by formula 1 below:

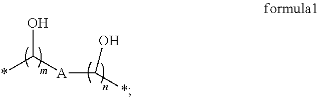

wherein A is a group comprising at least one of a phenoxy group or a biphenyl group, n is an integer greater than or equal to 1, and m is an integer greater than or equal to 1.

### CROSS-REFERENCE TO RELATED APPLICATION

This application claims priority to and the benefit of Chinese Patent Application No. 202410756962.3, filed on Jun. 12, 2024, the disclosure of which is incorporated herein by reference in its entirety.

### TECHNICAL FIELD

The present disclosure relates to display technologies, and in particular, to a display panel, an alignment film composition, and a display device.

### BACKGROUND

A conventional liquid crystal display panel includes an array substrate and a color film substrate disposed opposite to each other, and a liquid crystal layer disposed between the array substrate and the color film substrate. The array substrate provides a switching signal and a data signal, the color film substrate provides colorization, and the deflection of liquid crystal molecules in the liquid crystal layer controls the display brightness.

### SUMMARY

Some embodiments of the present disclosure provide a display panel comprising:
a first substrate;
a second substrate disposed opposite to the first substrate; and
a first alignment layer disposed on a side of the first substrate closer to the second substrate, the first alignment layer has a first polyimide molecular chain, and the first polyimide molecular chain comprises a unit represented by formula 1 below:

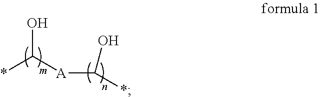

In the formula 1, Ais a group comprising at least one of a phenoxy group or a biphenyl group, n is an integer greater than or equal to 1, and m is an integer greater than or equal to 1.

In some embodiments of the present disclosure, the first polyimide molecular chain comprises a unit represented by formula 2 below:

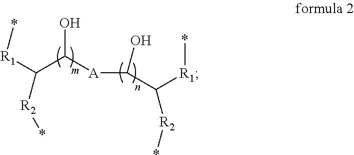

In the formula 2, R₁ is selected from a diamine subunit having a number of carbon atoms ranging from 1 to 50 and R₂ is selected from a dianhydride subunit having a number of carbon atoms ranging from 8 to 14.

In some embodiments of the present disclosure, the first polyimide molecular chain comprises a unit represented by formula 3 below:

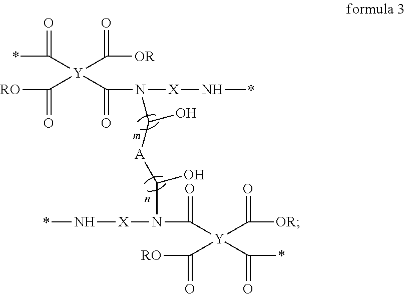

In the formula 3, X is selected from a substituted or unsubstituted aliphatic group having a number of carbon atoms ranging from 1 to 50 or a substituted or unsubstituted aromatic group having a number of carbon atoms from 6 to 50, Y is selected from a substituted or unsubstituted cycloalkyl group having a number of carbon atoms from 4 to 10, and R is selected from a hydrogen atom or a substituted or unsubstituted alkyl group having a number of carbon atoms ranging from 1 to 5.

In some embodiments of the present disclosure, the display panel further comprises a second alignment layer disposed on a side of the second substrate closer to the first substrate, the second alignment layer has a second polyimide molecular chain, and the second polyimide molecular chain comprises the unit represented by the formula 1.

In some embodiments of the present disclosure, A in the first polyimide molecular chain and Ain the second polyimide molecular chain are each independently selected from at least one of a group having a phenoxy group or a group having a biphenyl group.

In some embodiments of the present disclosure, the unit represented by formula 1 is selected from at least one of a group consisting of:

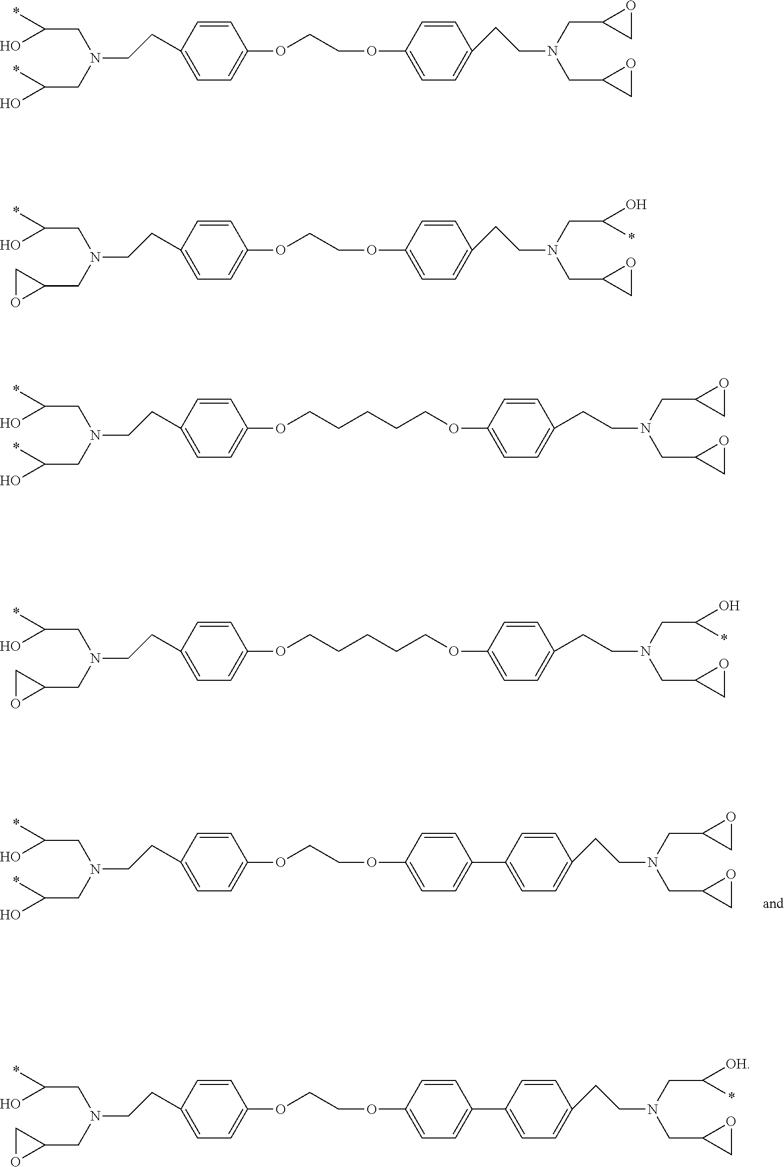

In some embodiments of the present disclosure, the display panel further comprises a liquid crystal layer disposed between the first alignment layer and the second alignment layer, the liquid crystal layer comprises liquid crystal molecules, and the liquid crystal molecules comprises at least one of the phenoxy group or the biphenyl group.

Some embodiments of the present disclosure further provide an alignment film composition, the alignment film composition comprises a diamine monomer, a dianhydride monomer, and an additive, the additive has a structure represented by formula 4 below:

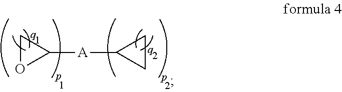

In the formula 4, Ais a group comprising at least one of a phenoxy group or a biphenyl group, and p₁, p₂, q₁, and q₂ are each an integer greater than or equal to 1.

In some embodiments of the present disclosure, the additive is present in a content of greater than or equal to 0.1% and less than or equal to 20% by mass in the liquid crystal composition.

In some embodiments of the present disclosure, the additive is at least one compound selected from a group consisting of:

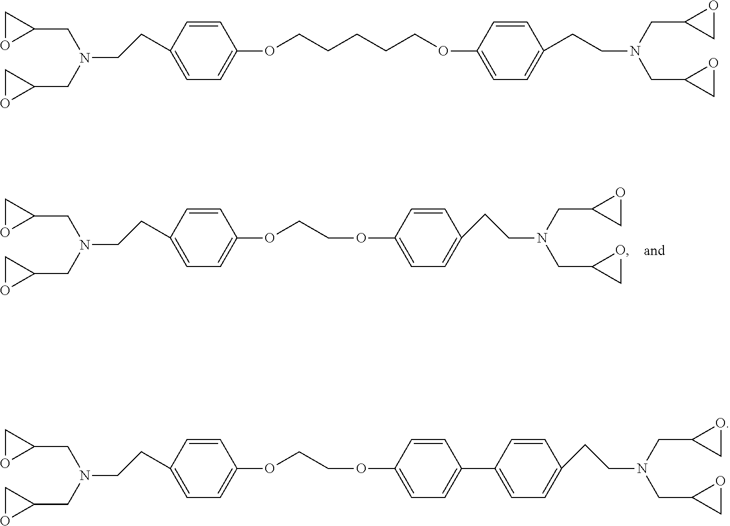 [SMILES: c1cc(OCCCCCOc2ccc(CCN(CC3CO3)CC3CO3)cc2)ccc1CCN(CC1CO1)CC1CO1 ; c1cc(OCCOc2ccc(CCN(CC3CO3)CC3CO3)cc2)ccc1CCN(CC1CO1)CC1CO1 ; c1cc(OCCOc2ccc(-c3ccc(CCN(CC4CO4)CC4CO4)cc3)cc2)ccc1CCN(CC1CO1)CC1CO1]

In accordance with the above object, some embodiments of the present disclosure further provide a display device. The display device comprises the display panel and a backlight module.

### BRIEF DESCRIPTION OF THE DRAWINGS

Embodiments are illustrated by way of example and are not limited in the accompanying figures.

FIG. 1 is a schematic diagram illustrating a structure of a display panel provided by some embodiments of the present disclosure;

FIG. 2 is a schematic diagram illustrating a structure of a polyimide molecular chain provided by some embodiments of the present disclosure;

FIG. 3 shows the NMR spectra of the compound M1 provided by some embodiments of the present disclosure;

FIG. 4 shows the NMR spectra of the compound M2 provided by some embodiments of the present disclosure;

FIG. 5 shows the NMR spectra of the compound M3 provided by some embodiments of the present disclosure;

FIG. 6 shows the NMR spectra of the compound Z1 provided by some embodiments of the present disclosure;

FIG. 7 is a schematic diagram illustrating a structure of a pixel electrode provided by some embodiments of the present disclosure;

FIG. 8 is a schematic diagram illustrating a structure of a display device provided by some embodiments of the present disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

Some embodiments of the present disclosure will be described in detail below in conjunction with the figures.

It should be understood that the described embodiments are only to illustrate and explain the present disclosure, but not intended to limit the present disclosure.

In the present disclosure, unless otherwise stated, the directional terms such as “up” and “down” generally refer to the top and bottom of the device in its actual use or working state, specifically the orientation of the drawing plane in the accompanying drawings; while the terms “inside” and “outside” are used in relation to a contour of the device. In the present disclosure, “optionally”, “optional”, or “option”, refers to presence or absence of an element, i.e., it refers to be selected from any one of two alternative technical solutions of “presence” and “absence”. If more than one term “optional” occurs in a technical solution, each of “optional” is independent of each other unless otherwise specified and unless there are contradictions or mutual constraints. In the present disclosure, the technical features described in an open-ended manner include a closed-ended technical solution consisted of the enumerated features, and also include an open-ended technical solution comprising the enumerated features.

In the present disclosure, an aromatic group, an aromatic, and an aromatic ring system have the same meaning and are interchangeable. “Aryl or aromatic group or aromatic ring system” means an aromatic hydrocarbon group derived by the removal of a hydrogen atom from an aromatic ring compound, which may be a monocyclic aryl group, a bicyclic aryl group or a polycyclic aryl group, and, in the case of the polycyclic system, at least one of the rings is an aromatic ring system. For example, “substituted or unsubstituted aryl group having 6 to 50 ring atoms” means an aryl group comprising 6 to 40 ring atoms, preferably a substituted or unsubstituted aryl group having 6 to 30 ring atoms, more preferably a substituted or unsubstituted aryl group having 6 to 18 ring atoms, and especially preferably a substituted or unsubstituted aryl group having 6 to 14 ring atoms, and optionally further substituted on the aryl group. Suitable examples include, but are not limited to: phenyl, biphenyl, triphenyl, naphthyl, anthracenyl, phenanthrenyl, fluoranthenyl, triphenylenyl, pyrenyl, perylenyl, naphthacenyl, fluorenyl, dinaphthylphenyl, acenaphthenyl and derivatives thereof. It will be appreciated, the plurality of aryl groups may also be interrupted by short non-aromatic units (e.g., <10% non-hydrogen atoms, such as C, N, or O atoms), specifically for example, acenaphthene, fluorene, or 9,9-diarylfluorene, triarylamine and diaryl ether systems should also be included in the definition of aryl.

In the present disclosure, a heteroaromatic group, a heteroaromatic, and a heteroaromatic ring system have the same meaning and are interchangeable. “Heteroaryl or heteroaromatic group or heteroaromatic ring system” means that at least one of the carbon atoms of the aryl group has been replaced by a non-carbon atom, which may be an N atom, an O atom, an S atom or the like. For example, “substituted or unsubstituted heteroaryl having 5 to 40 ring atoms” means a heteroaryl having 5 to 40 ring atoms, preferably substituted or unsubstituted heteroaryl having 6 to 30 ring atoms, more preferably substituted or unsubstituted heteroaryl having 6 to 18 ring atoms, particularly preferably substituted or unsubstituted heteroaryl having 6 to 14 ring atoms, and optionally further substituted. Suitable examples include, but are not limited to: thienyl, furanyl, pyrrolyl, diazolyl, triazolyl, imidazolyl, pyridinyl, bipyridinyl, pyrimidinyl, triazinyl, acridinyl, pyridazinyl, pyrazinyl, quinolinyl, isoquinolinyl, quinazolinyl, quinoxalinyl, phthalazinyl, pyridopyrimidinyl, pyridinopyrazinyl, benzothienyl, benzofuranyl, indolinyl, pyrroloimidazolyl, pyrrolo-pyrrolidinyl, thienopyrrolidinyl, thienothienyl, furanopyrrolidinyl, furazofuranyl, thienofuranyl, benzisoxazolyl, benzisothiazolyl, benzimidazolyl, o-diazanaphthyl, phenanthridinyl, perimidinyl, quinazolinonyl, dibenzothiophenyl, dibenzofuranyl, carbazolyl, and derivatives thereof.

In the present disclosure, “substituted” means that one or more hydrogen atoms in the substituted group are replaced by a substituent, and when the same substituent occurs more than once, it may be independently selected from different groups, e.g., if the general formula contains a plurality of R, then R may be independently selected from different groups. In some embodiments of the present disclosure, the term “substituted or unsubstituted” indicates that the defined group may or may not be substituted; when a defined group is substituted, it is to be understood that the defined group may be substituted with one or more substituents R. The substituents R are selected from, but not limited to: deuterium atom, cyano, isocyano, nitro or halogen, alkyl containing 1-20 carbon atoms, heterocyclyl containing 3-20 ring atoms, aromatic group containing 6-20 ring atoms, heteroaromatic group containing 5-20 ring atoms, —NR′R″, silyl, carbonyl, alkoxycarbonyl, aryloxycarbonyl, carbamoyl, halocarbonyl, formyl, isocyanato, thiocyanato, isothiocyanato, hydroxy, trifluoromethyl, and the above mentioned groups may also be further substituted with the substituents acceptable in the art. R′ and R″ in —NR′R″ are each independently selected from, but not limited to: H, a deuterium atom, a cyano, isocyano, nitro or halogen, an alkyl group containing 1-10 carbon atoms, a heterocyclic group containing 3-20 ring atoms, an aromatic group containing 6-20 ring atoms, a heteroaromatic group containing 5-20 ring atoms. Preferably, R is selected from, but not limited to: a deuterium atom, a cyano, an isocyano, a nitro or a halogen, an alkyl group containing 1-10 C atoms, a heterocyclyl group containing 3-10 ring atoms, an aromatic group containing 6-20 ring atoms, a heteroaromatic group containing 5-20 ring atoms, a silyl group, a carbonyl group, alkoxycarbonyl, aryloxycarbonyl, carbamoyl, halocarbonyl, formyl, isocyanato, thiocyanato, isothiocyanato, hydroxy, trifluoromethyl, and the above mentioned groups may also be further substituted with the substituents acceptable in the art.

In the present disclosure, the term “amine” means a derivative of an amine having the structural features of formula-NR′R″. R′ and R″ have the meanings described above.

In the present disclosure, “number of ring atoms” indicates the number of atoms constituting the ring itself of a structural compound (e.g., a monocyclic compound, a fused ring compound, a crosslinked compound, a carbocyclic compound, and a heterocyclic compound) obtained by bonding atoms together to form a ring. When the ring is substituted by a substituent group, the atoms contained in the substituent group are not included in the ring-forming atoms, and with regard to the term “number of ring atoms” described below, it is the same unless otherwise specified, e.g., the number of ring atoms for the benzene ring is 6, the number of ring atoms for the naphthalene ring is 10, and the number of ring atoms for the thiophene group is 5.

In the present disclosure, a “*” attached to a single bond indicates a linkage or a fused site.

In the present disclosure, when a linkage site is not specified in a group, it means that any of an optional linkable site in the group may be used as the linkage site.

In the present disclosure, when a fused site is not specified in a group, it means that any optional fused site in the group may be used as the fused site, and preferably two or more sites in neighboring positions in the group are the fused sites.

In the present disclosure, when a plurality of substituents represented by the same symbols are contained on the same group, the substituents may be the same or different from each other, for example, as for

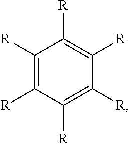

6 Rs in the benzene ring may be the same as each other or different from each other.

In the present disclosure, the single bond linked to the substituent penetrates through the corresponding ring, indicating that the substituent may be linked to the ring at an optional position, for example R in

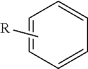

is linked to any substitutable site on the benzene ring; e.g.,

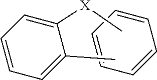

indicates

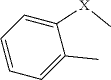

may form a ring with

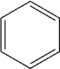

at any optional position on the benzene ring.

The cyclic alkyl or cycloalkyl as described in accordance with the present disclosure has the same meaning and are interchangeable.

In the present disclosure, the “neighboring groups” means that there is no substitutable site between the two substituents.

In the present disclosure, the phrase “two neighboring R₁ or R₃ or R₅ form a ring with each other” denotes that a ring system is formed by interconnecting two neighboring R₁, R₃ or R₅. The ring system may be selected from an aliphatic hydrocarbonyl ring, an aliphatic heterocyclic ring, an aromatic hydrocarbonyl ring or an aromatic heterocyclic ring. Preferably, the ring system may be formed from

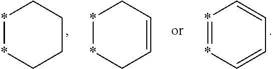

The conventional LCD panel provides an initial alignment to the liquid crystal molecules by forming an alignment film on the array substrate and the color film substrate. The pillar spacer (PS) located between the array substrate and the color film substrate in the LCD panel may move, which in turn causes friction with the alignment film, leading to scratch of the alignment film and generation of debris. There is the insufficient anchoring force and a crushed bright spot appears in the area where the alignment film is scratched, resulting in light leakage from the LCD panel in the dark state.

In order to solve the above problem, some embodiments of the present disclosure provide a display panel, an alignment film composition and a display device, all of which are capable of effectively enhancing the hardness of the first alignment layer and the anchoring force of the first alignment layer to the liquid crystal, and remedying the light leakage phenomenon of the display panel.

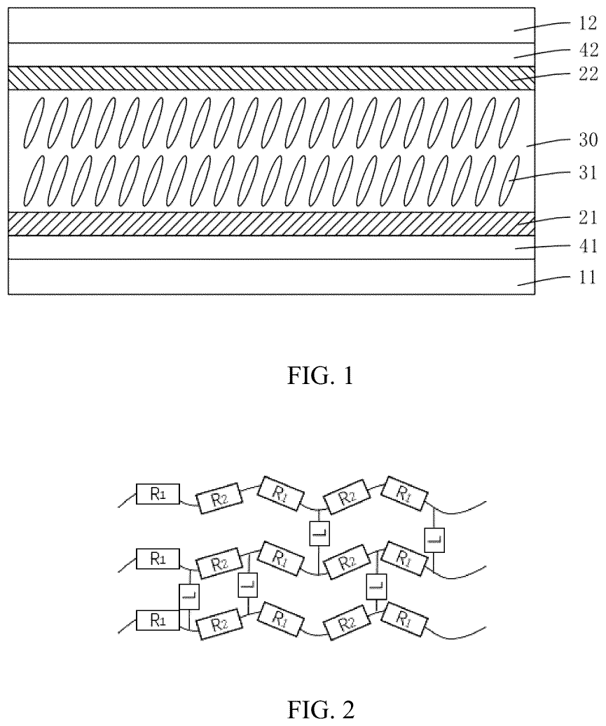

Referring to FIG. 1, some embodiments of the present disclosure provide a display panel. The display panel comprises a first substrate 11, a second substrate 12, and a first alignment layer 21. The first substrate 11 and the second substrate 12 are disposed opposite to each other. The first alignment layer 21 is disposed on a side of the first substrate 11 closer to the second substrate 12.

Further, the first alignment layer 21 has a first polyimide molecular chain. The first polyimide molecular chain comprises a unit represented by formula 1 below:

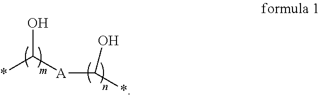

In the formula 1, Ais a group comprising at least one of a phenoxy group or a biphenyl group, n is an integer greater than or equal to 1, and m is an integer greater than or equal to 1.

In the process of implementation and application, according to some embodiments of the present disclosure, by forming a structure represented by the formula 1 in the first polyimide molecular chain of the first alignment layer 21, on the one hand, it is possible to increase the degree of crosslinking of the first alignment layer 21 so as to enhance the hardness of the first alignment layer 21 and reduce the probability that the first alignment layer 21 is scratched. On the other hand, the structure represented by the formula 1 has at least one of the phenoxy group or the biphenyl group, and both of the phenoxy and biphenyl groups are liquid crystal-like structures, which can thus effectively improve the anchoring force of the first alignment layer 21 to the liquid crystal, thus remedying the phenomenon of light leakage in the display panel.

It is to be noted that A comprising at least one of a phenoxy group or a biphenyl group means that the group represented by A comprises at least one of the phenoxy group or the biphenyl group, and the group represented by A may also comprise the groups other than the phenoxy and biphenyl groups, such as C, N, OH, and the like.

Further, with reference to FIGS. 1 and 2, the first polyimide molecular chain further comprises a diamine subunit R₁ and a dianhydride subunit R₂ formed by polymerization, and the unit L represented by the Formula 1 may be connected between the diamine subunit R₁ and the dianhydride subunit R₂ that are crosslinked together, such that the first polyimide molecular chain is crosslinked to form a network structure, which can further increase the crosslinking degree of the first polyimide molecular chain, i.e., increasing the cross-linking degree of the first alignment layer 21 so as to enhance the hardness of the first alignment layer 21 and reduce the probability that the first alignment layer 21 is scratched.

In some embodiments, the diamine subunit R₁ may be obtained by reaction of a diamine monomer. The diamine monomer may comprise at least one of p-phenylenediamine, m-phenylenediamine, 2,4-diaminotoluene, 2,5-diaminotoluene, 2,6-diaminotoluene, 2,4-dimethyl-1,3-diaminobenzene, 2,5-dimethyl-1,4-diaminobenzene, 2,3,5,6-tetramethyl-1,4-diamino benzene, 2,4-diaminophenol, 2,5-diaminophenol, 4,6-diaminoresorcinol, 2,5-diaminobenzoic acid, 3,5-diaminobenzoic acid, N,N-diallyl-2,4-diaminobenzenamine, N,N-diallyl-2,5-diaminobenzenamine, 4-aminobenzylamine, 3-aminobenzylamine, 2-(4-aminophenyl)ethylamine, 2-(3-amino phenyl)ethylamine, 1,5-naphthalenediamine, 2,7-naphthalenediamine, 4,4′-diaminobiphenyl, 3,4′-diaminobiphenyl, 3,3′-diaminobiphenyl, 2,2′-dimethyl-4,4′-di biphenyl, 3,3′-dimethyl-4,4′-diaminobiphenyl, 3,3′-dimethoxy-4,4′-diaminobiphenyl, 3,3′-dihydroxy-4,4′-diaminobiphenyl, 3,3′-dicarboxyl-4,4′-diaminobiphenyl, 3,3′-difluoro-4,4′-diaminobiphenyl, 2,2′-trifluoromethyl-4,4′-diaminobiphenyl, 3,3′-trifluoromethyl-4,4′-diaminobiphenyl, 4,4′-diaminodiphenylmethane, 3,3′-diaminodiphenylmethane, 3,4′-diaminodiphenylmethane, 4,4′-diaminodiphenyl ether, 3,3′-diaminodiphenyl ether, 3,4′-diaminodiphenyl ether, 4,4′-diaminodiphenyl sulfone, 3,3′-diaminodiphenyl sulfone, 4,4′-diaminodiphenylamine, 3,3′-diaminodiphenylamine, 3,4′-diaminodiphenylamine, N-methyl(4,4′-diaminodiphenyl)amine, N-methyl(3,3′-diaminodiphenyl)amine, N-methyl(3,4′-diaminodiphenyl)amine, 4,4′-diaminobenzophenone, 3,3′-diaminobenzophenone, 3,4′-diamino benzophenone, 4,4′-diamino-N-benzanilide, 1,2-bis(4-aminophenyl)ethane, 1,2-bis(3-aminophenyl)ethane, 4,4′-diaminodiphenylacetylene, 1,3-bis(4-aminophenyl)propane, 1,3-bis(3-aminophenyl)propane, 2,2-bis(4-aminophenyl)propane, 2,2-bis(3-aminophenyl)propane, 2,2-bis(3-amino-4-methylphenyl)propane, 2,2-bis(4-aminophenyl)hexafluoropropane, 2,2-bis(3-aminophenyl)hexafluoropropane, 2,2-bis(3-amino-4-methylphenyl)hexafluoropropane, 1,3-bis(4-aminophenoxy)propane, 1,4-bis(4-aminophenoxy)butane, 1,5-bis(4-aminophenoxy)pentane, 1,6-bis(4-aminophenoxy)hexane, 1,7-bis(4-aminophenoxy)heptane, 1,8-bis(4-aminophenoxy)octane, 1,9-bis(4-aminophenoxy)nonane, 1,10-bis(4-aminophenoxy)decane, 1,11-bis(4-aminophenoxy)undecane 1,12-bis(4-aminophenoxy)dodecane, bis(4-aminophenyl)malonate, bis(4-aminophenyl)butanedioate, bis(4-aminophenyl)glutarate, bis(4-aminophenyl)adipate, bis(4-aminophenyl)heptanedioate, bis(4-aminophenyl)suberate, bis(4-aminophenyl)octanedioate, bis(4-aminophenyl)nonanedioate, bis(4-aminophenyl)sebacate, 1,4-bis(4-aminophenyl)benzene, 1,3-bis(4-aminophenyl)benzene, 1,4-bis(4-aminophenoxy)benzene, 1,3-bis(4-aminophenoxy)benzene, 1,4-bis(4-aminophenylmethyl)benzene, 1,3-bis(4-aminophenylmethyl)benzene, bis(4-aminophenyl)terephthalate, bis(3-aminophenyl)terephthalate, bis(4-aminophenyl)isophthalate, bis(3-aminophenyl)isophthalate, 1,4-phenylene bis[(4-aminophenyl)methanone], 1,4-phenylene bis[(3-aminophenyl)methanone], 1,3-phenylene bis[(4-aminophenyl)methanone], 1,3-phenylene bis[(3-aminophenyl)methanone], 1,4-phenylene bis(4-aminobenzoate), 1,4-phenylene bis(3-aminobenzoate), 1,3-phenylene bis(4-aminobenzoate), 1,3-phenylene bis(3-aminobenzoate), N,N′-(1,4-phenylene) bis(4-aminobenzamide), N,N′-(1,3-phenylene) bis(4-aminobenzoate), N,N′-(1,3-phenylene) bis(4-aminobenzoic formamide), N,N′-(1,4-phenylene)bis(3-aminobenzamide), N,N′-(1,3-phenylene)bis(3-aminobenzamide), bis(4-aminophenyl)terephthalamide, bis(3-aminophenyl)terephthalamide, bis(4-aminophenyl)isophthalamide, bis(3-aminophenyl)isophthalamide, 2,2-bis[4-(4-aminophenoxy)phenyl]propane, 2,2-bis[4-(4-aminophenoxy)phenyl]hexafluoropropane, 4,4′-bis(4-aminophenoxy)diphenyl sulfone, 2,6-diaminopyridine, 2,4-diaminopyridine, 2,4-diamino-1,3,5-triazine, 2,6-diaminodibenzofuran, 2,7-diaminodibenzofuran, 3,6-diaminodibenzofuran, 2,6-diaminocarbazole, 2,7-diaminocarbazole, 3,6-diaminocarbazole, 2,4-diamino-6-isopropyl-1,3,5-triazine, 2,5-bis(4-aminophenyl)-1,3,4-oxadiazole, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,4-diaminocyclohexane, 1,3-diaminocyclohexane, bis(4-aminocyclohexyl) methane, and/or bis(4-amino-3-methylcyclohexyl)methane.

In some embodiments, the dianhydride subunit R₂ may be obtained by reaction of the dianhydride monomer, and the dianhydride monomer may comprise at least one of 1,2,3,4-cyclobutanetetracarboxylic acid dianhydride (CBDA), and other aromatic dianhydride compounds, for example, the dianhydride monomer may further comprise at least one of pyromellitic dianhydride, 2,3,6,7-naphthalene tetracarboxylic acid dianhydride, 1,2,5,6-naphthalene tetracarboxylic acid dianhydride, 1,4,5,8-naphthalenetetracarboxylic acid dianhydride, 2,3,6,7-anthracenetetracarboxylic acid dianhydride, 1,2,5,6-anthracenetetracarboxylic acid dianhydride, 3,3′,4,4′-biphenyltetracarboxylic acid dianhydride, 2,2′,3,3′-biphenyltetracarboxylic acid dianhydride, 2,3,3′,4′-biphenyltetracarboxylic acid dianhydride, 3,3′,4,4′-benzophenone tetracarboxylic acid dianhydride, 2,3,3′,4′-benzophenone tetracarboxylic acid dianhydride, bis(3,4-dicarboxyphenyl)methane dianhydride, bis(3,4-dicarboxyphenyl)ether dianhydride, bis(3,4-dicarboxyphenyl)sulfone dianhydride, 2,2-bis(3,4-dicarboxyphenyl)propane dianhydride, 2,2-bis(3,4-dicarboxyphenyl)hexafluoropropane dianhydride, 2,5-dicarboxymethylterephthalic acid dianhydride, 4,6-dicarboxymethylisophthalic acid dianhydride, 4-(2,5-dioxotetrahydro-3-furyl) phthalic anhydride, 1,4-bis(2,5-dioxotetrahydro-3-furyl) benzene, 1,4-bis(2,6-dioxotetrahydro-4-pyranyl)benzene, 1,4-bis(2,5-dioxotetrahydro-3-methyl-3-furyl) benzene, 1,4-bis(2,6-dioxotetrahydro-4-methyl-4-pyranyl) benzene, 1,2,3,4-butanetetracarboxylic acid dianhydride, 1,2,3,4-cyclobutanetetracarboxylic acid dianhydride, 1,2-dimethyl-1,2,3,4-cyclobutanetetracarboxylic acid dianhydride, 1,3-dimethyl-1,2,3,4-cyclobutanetetracarboxylic acid dianhydride, 1,2,3,4-tetramethyl-1,2,3,4-cyclobutane tetracarboxylic acid dianhydride, 1,2,3,4-cyclopentane tetracarboxylic acid dianhydride, 2,3,4,5-tetrahydrofuran tetracarboxylic acid dianhydride, 2,3,5-tricarboxycyclopentylacetic acid dianhydride, 1,2,4,5-cyclohexane tetracarboxylic acid dianhydride, 4-(2,5-dioxo-tetrahydro-3-furyl)-cyclohexane-1,2-dicarboxylic acid dianhydride, 5-(2,5-dioxotetrahydro-3-furyl)-3-methyl-3-cyclohexene-1,2-dicarboxylic acid dianhydride, dicyclo[2.2.2]oct-7-ene-2,3,5,6-tetracarboxylic acid dianhydride, 3,4-dicarboxyl-1,2,3,4-tetrahydro-1-naphthalenesuccinic acid dianhydride, 3,4-dicarboxyl-1,2,3,4-tetrahydro-6-methyl-1-naphthalenesuccinic acid dianhydride, bicyclo[3.3.0]octane-2,4,6,8-tetracarboxylic acid dianhydride, and/or 3,3′,4,4′-dicyclohexyltetracarboxylic acid dianhydride.

Further, in some embodiments, the first polyimide molecular chain comprises the unit represented by formula 2 below:

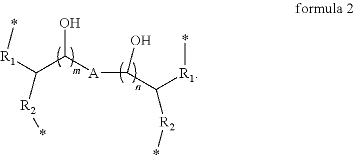

In the formula 2, R₁ is selected from the diamine subunit having a number of carbon atoms ranging from 1 to 50, and R₂ is selected from the dianhydride subunit having a number of carbon atoms ranging from 8 to 14, i.e., the diamine monomer and the dianhydride monomer that satisfy the required number of carbon atoms may be selected from the diamine monomers and dianhydride monomers exemplified in the foregoing embodiments to carry out the reaction. R₁ is derived from the diamine monomer and R₂ is derived from the dianhydride monomer.

In some embodiments, the first polyimide molecular chain comprises the unit represented by the formula 3 below:

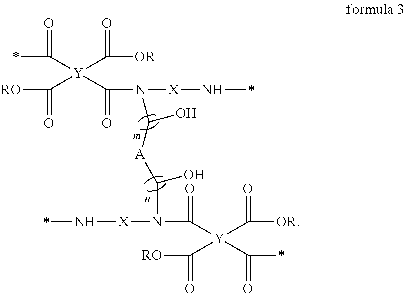

In the formula 3, X is selected from a substituted or unsubstituted aliphatic group having a number of carbon atoms ranging from 1 to 50, or a substituted or unsubstituted aromatic group having a number of carbon atoms ranging from 6 to 50, Y is selected from a substituted or unsubstituted cyclic alkyl having a number of carbon atoms ranging from 4 to 10, and R is selected from a hydrogen atom or a substituted or unsubstituted alkyl group having a number of carbon atoms ranging from 1 to 5.

In some embodiments, X may be phenyl, and Y may be

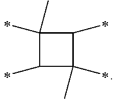

R may be hydrogen atom. Therefore, the corresponding diamine monomer is

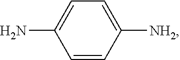

and the corresponding dianhydride monomer is

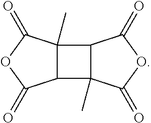 [SMILES: CC12C(=O)OC(=O)C1C1(C)C(=O)OC(=O)C21]

In some embodiments, m is less than or equal to 6 and n is less than or equal to 6, e.g., m may be equal to 1, 2, 3, 4, 5, or 6, and n may be equal to 1, 2, 3, 4, 5, or 6. It should be noted that m and n are used to denote only the number of C and do not include OH.

Further, referring back to FIG. 1, in some embodiments, the display panel further comprises a second alignment layer 22 disposed on the side of the second substrate 12 closer to the first substrate 11. The second alignment layer 22 has a second polyimide molecular chain, and the second polyimide molecular chain comprises the unit represented by the formula 1.

It is to be noted that the Ain the first polyimide molecular chain and the Ain the second polyimide molecular chain are each independently selected from at least one of a group having a phenoxy group or the group having a biphenyl group, i.e., the first polyimide molecular chain and the second polyimide molecular chain may be the same or different. When the first polyimide molecular chain and the second polyimide molecular chain are different, it may be either the case that the units represented by the Formula 1 in the first polyimide molecular chain and the second polyimide molecular chain are different, or the case that the unit represented by the formula 1 in the first polyimide molecular chain and the unit represented by the formula 1 in the second polyimide molecular chain are connected to the diamine structure and the dianhydride structure in the different manner, which are not limited hereto.

In some embodiments of the present disclosure, the unit represented by the formula 1 is at least one selected from a group consisting of:

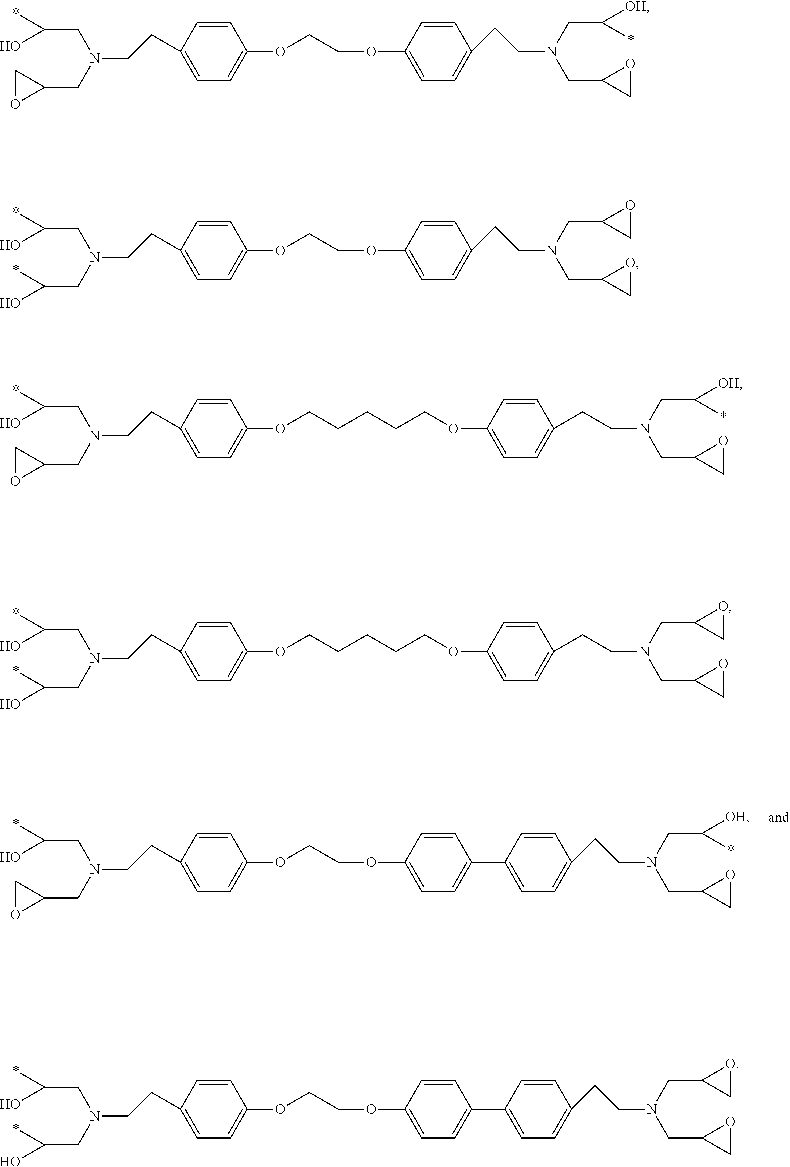

It should be noted that in the implementation and application process, the alignment layer in the display panel may be hydrolyzed, and the product after hydrolysis may be analyzed by MALDI-MS (matrix-assisted laser desorption ionization technique), thermal cracking GC/MS (thermal cracking-gas chromatography/mass spectrometry technique), HPLC (high-performance liquid chromatography), LCMS (liquid chromatography), GC (gas chromatography), GCMS (Gas Chromatography-Mass Spectrometry), NMR (Nuclear Magnetic Resonance Technique), ICP-OES (Inductively Coupled Plasma Emission Spectrometry), EDS (X-Ray Energy Spectrometry), ESR (Electron Paramagnetic Resonance) and other test means to validate that the alignment layer comprises the unit represented by the formula 1 provided by some embodiments of the present disclosure.

In some embodiments, the display panel further comprises a liquid crystal layer 30 disposed between the first alignment layer 21 and the second alignment layer 22. The liquid crystal layer 30 comprises liquid crystal molecules 31. The liquid crystal molecules in 31 comprise at least one of the phenoxy group or the biphenyl group. Thus, the unit represented by the formula 1 has a similar group to that in the liquid crystal molecule 31, which can increase the anchoring force of the first alignment layer 21 and the second alignment layer 22 to the liquid crystal.

In some embodiments, the liquid crystal molecule 31 may be selected from at least one of the following compounds:

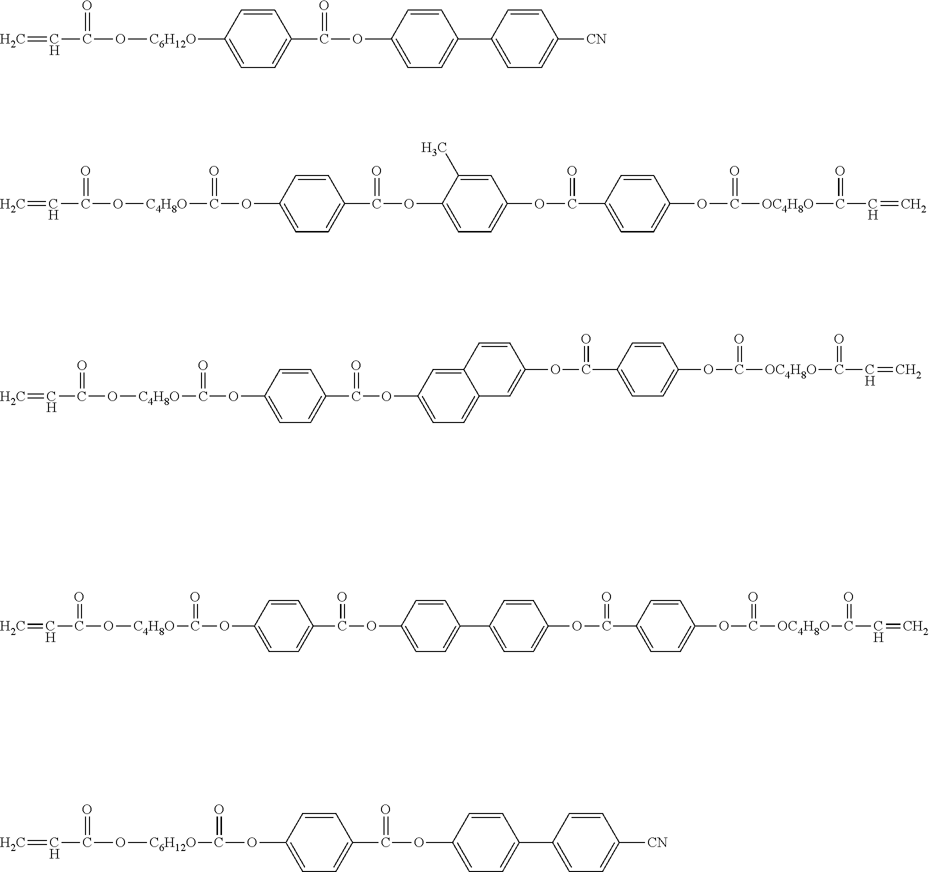

Referring back to FIG. 1, in some embodiments, the display panel further comprises a first electrode layer 41 disposed on the first substrate 11, and a second electrode layer 42 disposed on the second substrate 12. The liquid crystal layer 30 comprises liquid crystal molecules 31 disposed between the first electrode layer 41 and the second electrode layer 42.

It is noted that one of the first substrate 11 and the second substrate 12 may be an array substrate, and the other of the first substrate 11 and the second substrate 12 may be a color film substrate. For example when the first substrate 11 the an array substrate, then the second substrate 12 is the color film substrate, the first electrode layer 41 may be a pixel electrode, the second electrode layer 42 may be a common electrode, and an electric field may be generated between the first electrode layer 41 and the second electrode layer 42 such that the deflection of the liquid crystal molecules 31 in the liquid crystal layer 30 is adjusted to control the amount of light passing through the liquid crystal layer 30.

In some embodiments, both the first electrode layer 41 and the second electrode layer 42 may be prepared using a transparent conductive material, such as an indium tin oxide (ITO) material.

In some embodiments, the liquid crystal layer 30 has a thickness greater than or equal to 0.1 μm and less than or equal to 100 μm, and further preferably, the liquid crystal layer 30 has a thickness greater than or equal to 1 μm and less than or equal to 5 μm. The liquid crystal layer 30 may comprise single molecules of the liquid crystal, single crystals of the liquid crystal, or mixed crystals of the liquid crystal.

In some embodiments, the first alignment layer 21 may have a thickness greater than or equal to 0.1 nm and less than or equal to 2 μm, and further preferably, the first alignment layer 21 may have a thickness greater than or equal to 10 nm and less than or equal to 200 nm; the second alignment layer 22 may have a thickness greater than or equal to 0.1 nm and less than or equal to 2 μm, and further preferably, the second alignment layer 22 may have a thickness greater than or equal to 10 nm and less than or equal to 200 nm.

In some embodiments, the orientation angle of the first alignment layer 21 and the orientation angle of the second alignment layer 22 is irrelevant therebetween, and the respective orientation angle of the two may be optional, preferably the orientation of the first alignment layer 21 is parallel to the orientation of the second alignment layer 22 or the orientation of the first alignment layer 21 is perpendicular to the orientation of the second alignment layer at an angle of 90°.

As described above, according to some embodiments of the present disclosure, by forming the structure as represented by the Formula 1 in the first polyimide molecular chain of the first alignment layer 21 and the second polyimide molecular chain 22, on one hand, the cross-linking degree of the first alignment layer 21 and the second alignment layer 22 can be increased to enhance the hardness of the first alignment layer 21 and the second alignment layer 22, and reduce the probability that the first alignment layer 21 and the second alignment layer 22 will be scratched. On the other hand, the structure represented by the formula 1 has at least one of the phenoxy group or the biphenyl group, and the phenoxy and biphenyl groups are both liquid crystal-like structures, which can effectively increase the anchoring force of the first ligand layer 21 and the second ligand layer 22 to the liquid crystals, and thus can remedy the phenomenon of light leakage in the display panel.

Additionally, some embodiments of the present disclosure provide a alignment film composition. The alignment film composition comprises a diamine monomer, a dianhydride monomer, and an additive, the additive has the structure represented by formula 4 below:

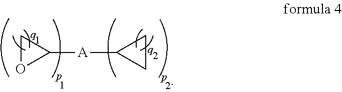

In the formula 4, A is a group comprising at least one of the phenoxy group or the biphenyl group, and p₁, p₂, q₁, and q₂ are integers greater than or equal to 1.

In some embodiments, p₁, p₂, q₁, and q₂ may each be less than or equal to 6, for example, p₁, p₂, q₁, and q₂ may each be independently selected from any of 1, 2, 3, 4, 5, or 6.

In some embodiments of the present disclosure, the additive is present in a content of greater than or equal to 0.1% and less than or equal to 20% by mass in the liquid crystal composition. It is noted that in the alignment composition provided by some embodiments of the present disclosure, the molar ratio of the diamine monomer to the dianhydride monomer is 1:1. The additive may have a proportion by mass of 0.1%, 1%, 2%, 3%, 4%, 5%, 6%, 7%, 8%, 9%, 10%, 11%, 12%, 13%, 14%, 15%, 16%, 17%18%, 19%, or 20% in the liquid crystal composition.

In some embodiments, the additive may be at least one selected from a group consisting of.

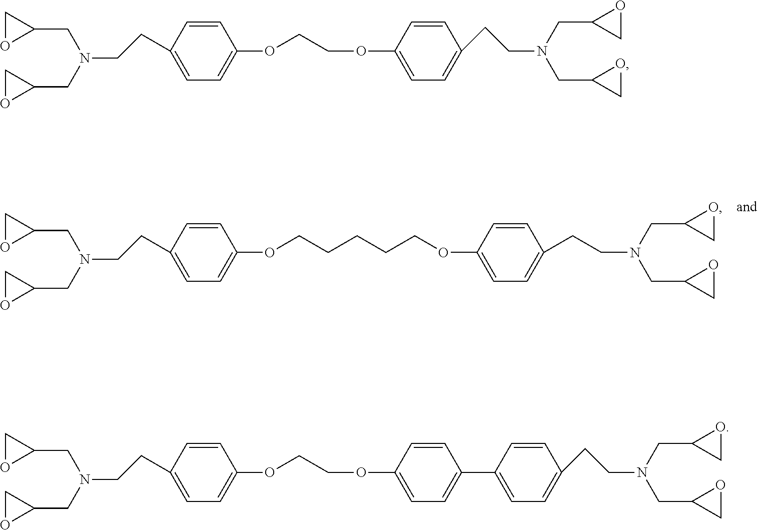 [SMILES: c1cc(OCCOc2ccc(CCN(CC3CO3)CC3CO3)cc2)ccc1CCN(CC1CO1)CC1CO1 ; c1cc(OCCCCCOc2ccc(CCN(CC3CO3)CC3CO3)cc2)ccc1CCN(CC1CO1)CC1CO1 ; c1cc(OCCOc2ccc(-c3ccc(CCN(CC4CO4)CC4CO4)cc3)cc2)ccc1CCN(CC1CO1)CC1CO1]

In some embodiments, the diamine monomer may comprise at least one of p-phenylenediamine, m-phenylenediamine, 2,4-diaminotoluene, 2,5-diaminotoluene, 2,6-diaminotoluene, 2,4-dimethyl-1,3-diaminobenzene, 2,5-dimethyl-1,4-diaminobenzene, 2,3,5,6-tetramethyl-1,4-diamino benzene, 2,4-diaminophenol, 2,5-diaminophenol, 4,6-diaminoresorcinol, 2,5-diaminobenzoic acid, 3,5-diaminobenzoic acid, N,N-diallyl-2,4-diaminobenzenamine, N,N-diallyl-2,5-diaminobenzenamine, 4-aminobenzylamine, 3-aminobenzylamine, 2-(4-aminophenyl)ethylamine, 2-(3-amino phenyl)ethylamine, 1,5-naphthalenediamine, 2,7-naphthalenediamine, 4,4′-diaminobiphenyl, 3,4′-diaminobiphenyl, 3,3′-diaminobiphenyl, 2,2′-dimethyl-4,4′-di biphenyl, 3,3′-dimethyl-4,4′-diaminobiphenyl, 3,3′-dimethoxy-4,4′-diaminobiphenyl, 3,3′-dihydroxy-4,4′-diaminobiphenyl, 3,3′-dicarboxyl-4,4′-diaminobiphenyl, 3,3′-difluoro-4,4′-diaminobiphenyl, 2,2′-trifluoromethyl-4,4′-diaminobiphenyl, 3,3′-trifluoromethyl-4,4′-diaminobiphenyl, 4,4′-diaminodiphenylmethane, 3,3′-diaminodiphenylmethane, 3,4′-diaminodiphenylmethane, 4,4′-diaminodiphenyl ether, 3,3′-diaminodiphenyl ether, 3,4′-diaminodiphenyl ether, 4,4′-diaminodiphenyl sulfone, 3,3′-diaminodiphenyl sulfone, 4,4′-diaminodiphenylamine, 3,3′-diaminodiphenylamine, 3,4′-diaminodiphenylmethane, N-methyl(4,4′-diaminodiphenyl)amine, N-methyl(3,3′-diaminodiphenyl)amine, N-methyl(3,4′-diaminodiphenyl)amine, 4,4′-diaminobenzophenone, 3,3′-diaminobenzophenone, 3,4′-diamino benzophenone, 4,4′-diamino-N-benzanilide, 1,2-bis(4-aminophenyl)ethane, 1,2-bis(3-aminophenyl)ethane, 4,4′-diaminodiphenylacetylene, 1,3-bis(4-aminophenyl)propane, 1,3-bis(3-aminophenyl)propane, 2,2-bis(4-aminophenyl)propane, 2,2-bis(3-aminophenyl)propane, 2,2-bis(3-amino-4-methylphenyl)propane, 2,2-bis(4-aminophenyl)hexafluoropropane, 2,2-bis(3-aminophenyl)hexafluoropropane, 2,2-bis(3-amino-4-methylphenyl)hexafluoropropane, 1,3-bis(4-aminophenoxy)propane, 1,4-bis(4-aminophenoxy)butane, 1,4-bis(4-aminophenoxy)butane, 1,5-bis(4-aminophenoxy)pentane, 1,6-bis(4-aminophenoxy)hexane, 1,7-bis(4-aminophenoxy)heptane, 1,8-bis(4-aminophenoxy)octane, 1,9-bis(4-aminophenoxy)nonane, 1,10-bis(4-aminophenoxy)decane, 1,11-bis(4-aminophenoxy)undecane 1,12-bis(4-aminophenoxy)dodecane, bis(4-aminophenyl)malonate, bis(4-aminophenyl)butanedioate, bis(4-aminophenyl)glutarate, bis(4-aminophenyl)adipate, bis(4-aminophenyl)heptanedioate, bis(4-aminophenyl)suberate, bis(4-aminophenyl)octanedioate, bis(4-aminophenyl)nonanedioate, bis(4-aminophenyl)sebacate, 1,4-bis(4-aminophenyl)benzene, 1,3-bis(4-aminophenyl)benzene, 1,4-bis(4-aminophenoxy)benzene, 1,3-bis(4-aminophenoxy)benzene, 1,4-bis(4-aminophenylmethyl)benzene, 1,3-bis(4-aminophenylmethyl)benzene, bis(4-aminophenyl)terephthalate, bis(3-aminophenyl)terephthalate, bis(4-aminophenyl)isophthalate, bis(3-aminophenyl)isophthalate, 1,4-phenylene bis[(4-aminophenyl)methanone], 1,4-phenylene bis[(3-aminophenyl)methanone], 1,3-phenylene bis[(4-aminophenyl)methanone], 1,3-phenylene bis[(3-aminophenyl)methanone], 1,4-phenylene bis(4-aminobenzoate), 1,4-phenylene bis(3-aminobenzoate), 1,3-phenylene bis(4-aminobenzoate), 1,3-phenylene bis(3-aminobenzoate), N,N′-(1,4-phenylene) bis(4-aminobenzamide), N,N′-(1,3-phenylene) bis(4-aminobenzoate), N,N′-(1,3-phenylene) bis(4-aminobenzoic formamide), N,N′-(1,4-phenylene)bis(3-aminobenzamide), N,N′-(1,3-phenylene)bis(3-aminobenzamide), bis(4-aminophenyl)terephthalamide, bis(3-aminophenyl)terephthalamide, bis(4-aminophenyl)isophthalamide, bis(3-aminophenyl)isophthalamide, 2,2-bis[4-(4-aminophenoxy)phenyl]propane, 2,2-bis[4-(4-aminophenoxy)phenyl]hexafluoropropane, 4,4′-bis(4-aminophenoxy)diphenyl sulfone, 2,6-diaminopyridine, 2,4-diaminopyridine, 2,4-diamino-1,3,5-triazine, 2,6-diaminodibenzofuran, 2,7-diaminodibenzofuran, 3,6-diaminodibenzofuran, 2,6-diaminocarbazole, 2,7-diaminocarbazole, 3,6-diaminocarbazole, 2,4-diamino-6-isopropyl-1,3,5-triazine, 2,5-bis(4-aminophenyl)-1,3,4-oxadiazole, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,4-diaminocyclohexane, 1,3-diaminocyclohexane, bis(4-aminocyclohexyl) methane, and/or bis(4-amino-3-methylcyclohexyl)methane.

In some embodiments, the dianhydride monomer may comprise at least one of 1,2,3,4-cyclobutanetetracarboxylic acid dianhydride (CBDA), and other aromatic dianhydride compounds, for example, the dianhydride monomer may also comprise at least one of pyromellitic dianhydride, 2,3,6,7-naphthalenetetracarboxylic acid dianhydride, 1,2,5,6-naphthalenetetracarboxylic acid dianhydride, 1,4,5,8-naphthalenetetracarboxylic acid dianhydride, 2,3,6,7-anthracenetetra dianhydride, 1,2,5,6-anthracenetetracarboxylic acid dianhydride, 3,3′,4,4′-biphenyltetracarboxylic acid dianhydride, 2,2′,3,3′-biphenyltetracarboxylic acid dianhydride, 2,3,3′,4′-biphenyltetracarboxylic acid dianhydride, 3,3′,4,4′-benzophenone tetracarboxylic acid dianhydride, 2,3,3′,4′-benzophenone tetracarboxylic acid dianhydride, bis(3,4-dicarboxyphenyl)methane dianhydride, bis(3,4-dicarboxyphenyl)ether dianhydride, bis(3,4-dicarboxyphenyl)sulfone dianhydride, 2,2-bis(3,4-dicarboxyphenyl)propane dianhydride, 2,2-bis(3,4-dicarboxyphenyl)hexafluoropropane dianhydride, 2,5-dicarboxymethyl terephthalic anhydride, 4,6-dicarboxymethyl isophthalic dianhydride, 4-(2,5-dioxotetrahydro-3-furyl) phthalic anhydride, 1,4-bis(2,5-dioxidotetrahydro-3-furyl)benzene, 1,4-bis(2,6-dioxidotetrahydro-4-pyranyl)benzene, 1,4-bis(2,5-dioxidotetrahydro-3-methyl-3-furyl)benzene, 1,4-bis(2,6-dioxidotetrahydro-4-methyl-4-pyranyl)benzene, 1,2,3,4-butanetetracarboxylic acid dianhydride, 1,2,3,4-cyclobutanetetracarboxylic acid dianhydride, 1,2-dimethyl-1,2,3,4-cyclobutanetetracarboxylic acid dianhydride, 1,3-dimethyl-1,2,3,4-cyclobutanetetracarboxylic acid dianhydride, 1,2,3,4-cyclopentanetetracarboxylic acid dianhydride, 2,3,4,5-tetrahydrofuranetetracarboxylic acid dianhydride, 2,3,5-tricarboxycyclopentylacetic acid dianhydride, 1,2,4,5-cyclohexane tetracarboxylic acid dianhydride, 4-(2,5-dioxotetrahydro-3-furyl)-cyclohexane-1,2-dicarboxylic acid dianhydride, 5-(2,5-dioxotetrahydro-3-furyl)-3-methyl-3-cyclohexene-1,2-dicarboxylic anhydride, dicyclo[2.2.2]oct-7-ene-2,3,5,6-tetracarboxylic acid dianhydride, 3,4-dicarboxyl-1,2,3,4-tetrahydro-1-naphthalenesuccinic acid dianhydride, 3,4-dicarboxyl-1,2,3,4-tetrahydro-6-methyl-1-naphthalenesuccinic acid dianhydride, bicyclo[3.3.0]octane-2,4,6,8-tetracarboxylic acid dianhydride, or 3,3′,4,4′-dicyclohexyltetracarboxylic acid dianhydride.

Further, in some embodiments, the diamine monomer may have a number of carbon atoms ranging from 1 to 50 and the dianhydride monomer may have a number of carbon atoms ranging from 8 to 14. For example the corresponding diamine monomer is

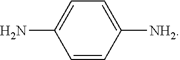

The corresponding dianhydride monomer is

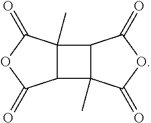 [SMILES: CC12C(=O)OC(=O)C1C1(C)C(=O)OC(=O)C21]

By forming the structure as represented by the Formula 1 in the first polyimide molecular chain of the first alignment layer, on one hand, the cross-linking degree of the first alignment layer can be increased to enhance the hardness of the first alignment layer and reduce the probability that the first alignment layer will be scratched. On the other hand, the structure represented by the formula 1 has at least one of the phenoxy group or the biphenyl group, and the phenoxy and biphenyl groups are both liquid crystal-like structures, which can effectively increase the anchoring force of the first ligand layer to the liquid crystals, and thus can remedy the phenomenon of light leakage in the display panel.

Furthermore, some embodiments of the present disclosure are provided in conjunction with Examples in the preparation of the additive in the above embodiments.

### Compound M1

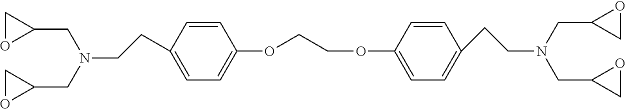 [SMILES: c1cc(OCCOc2ccc(CCN(CC3CO3)CC3CO3)cc2)ccc1CCN(CC1CO1)CC1CO1]

The compound M1 was synthesized by the following scheme:

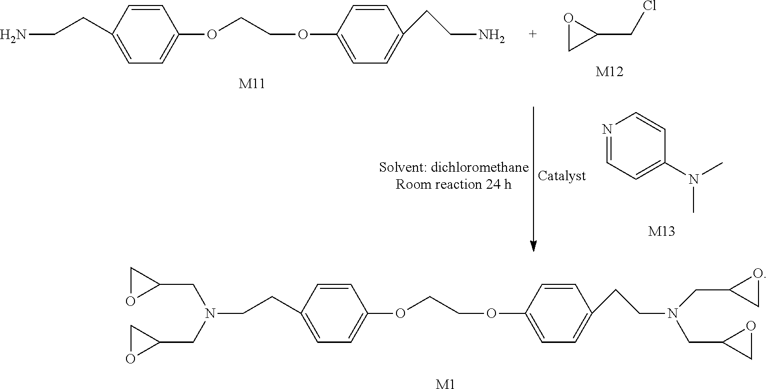

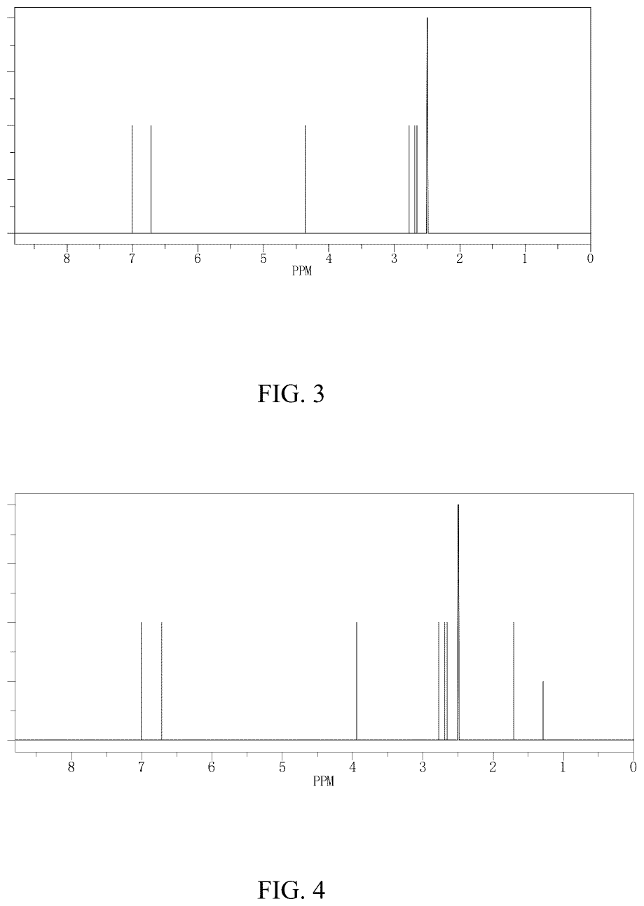

The reactants M11 and M12 with a molar ratio of 1:4 were dissolved in a dichloromethane solvent and the catalyst M13 was added and reacted at room temperature for 24 h to obtain the product M1. The NMR spectrum of the product M1 is shown in FIG. 3.

### Compound M2:

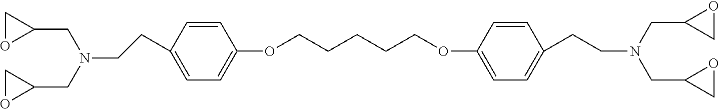 [SMILES: c1cc(OCCCCCOc2ccc(CCN(CC3CO3)CC3CO3)cc2)ccc1CCN(CC1CO1)CC1CO1]

The synthesis process of the compound M2 is shown below:

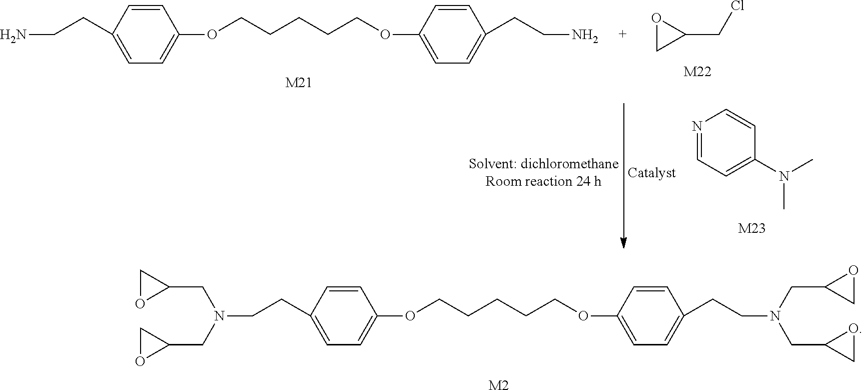

The reactants M21 and M22 with a molar ratio of 1:4 were dissolved in a dichloromethane solvent and the catalyst M23 was added thereto and reacted at room temperature for 24 h to obtain the product M2. The NMR spectrum of the product M2 is shown in FIG. 4.

### Compound M3:

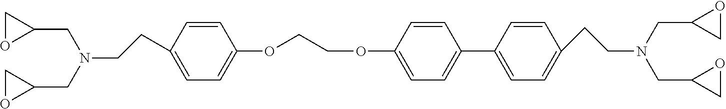 [SMILES: c1cc(OCCOc2ccc(-c3ccc(CCN(CC4CO4)CC4CO4)cc3)cc2)ccc1CCN(CC1CO1)CC1CO1]

The synthesis process of compound M3 is shown below:

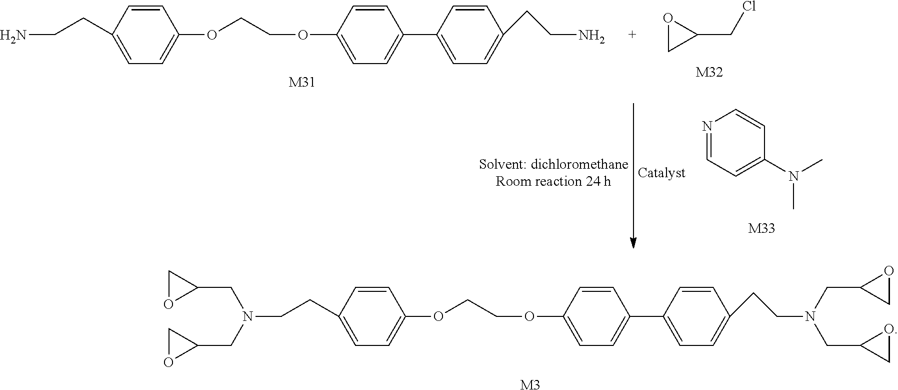

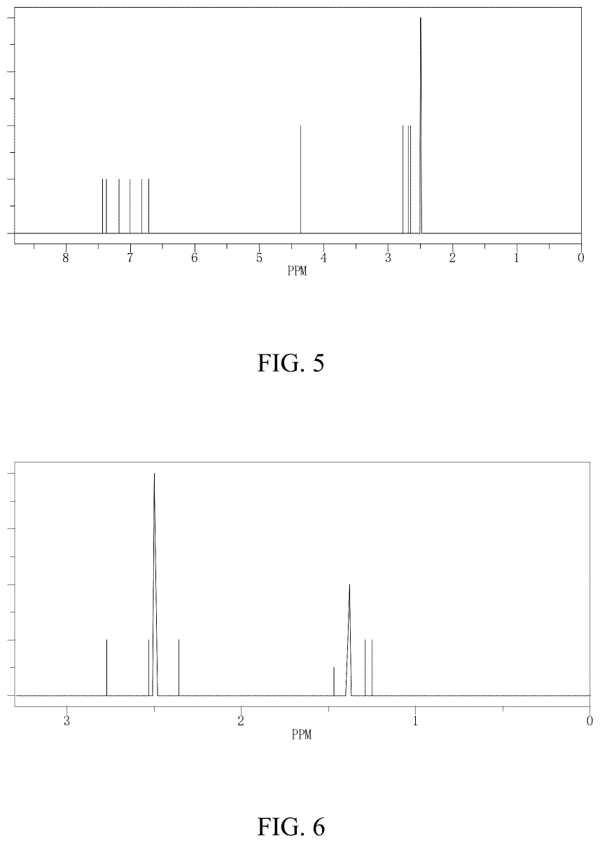

The reactants M31 and M32 with a molar ratio of 1:4 were dissolved in a dichloromethane solvent and the catalyst M33 was added thereto and reacted at room temperature for 24 h to obtain the product M3. The NMR spectrum of the product M3 is shown in FIG. 5.

Hereinafter, Comparative Examples 1 and 2 and Examples 1 to 3 are provided according to some embodiments of the present disclosure provide and the performance of the alignment film composition and the display panel provided by some embodiments of the present disclosure is validated.

In the Comparative Example 1, the polyimide PI-1 was obtained by polymerization reaction of p-phenylenediamine

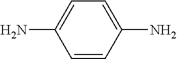

and 1,3-dimethylcyclobutanetetracarboxylic acid

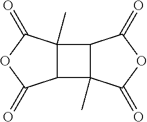 [SMILES: CC12C(=O)OC(=O)C1C1(C)C(=O)OC(=O)C21]

at a molar ratio of 50:50.

In the Comparative Example 2, the polyimide was obtained by polymerization reaction of p-phenylenediamine and 1,3-dimethylcyclobutane tetracarboxylic acid at a molar ratio of 50:50, and the polyimide PI-2 was prepared by adding 5 wt % of a comparative additive thereto. The structure of the comparative additive in the Comparative Example 2 is shown below:

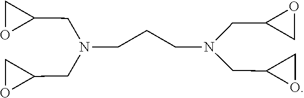 [SMILES: C(CN(CC1CO1)CC1CO1)CN(CC1CO1)CC1CO1]

The comparative additive was synthesized by the following scheme:

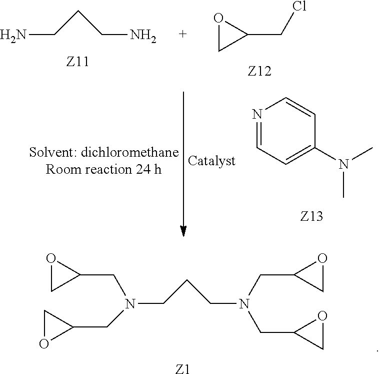

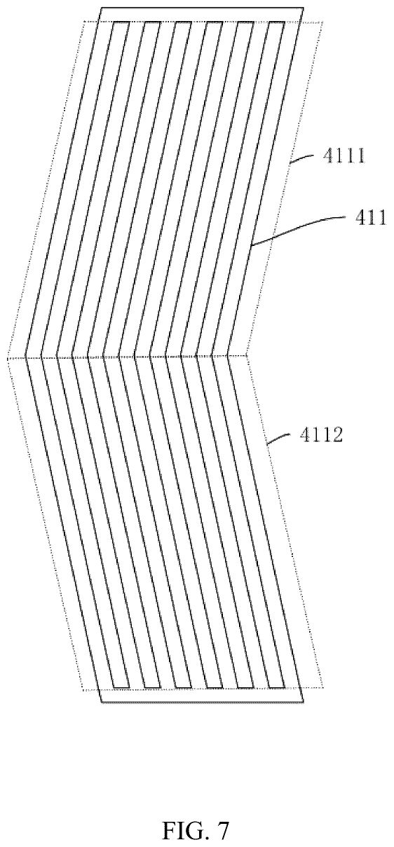

The reactants Z11 and Z12 with a molar ratio of 1:4 were dissolved in a dichloromethane solvent and the catalyst Z13 was added thereto, and reacted at room temperature for 24 h to obtain the product Z1. The NMR spectrum of the product Z1 is shown in FIG. 6.

In Example 1, a polyimide was obtained by polymerization reaction of p-phenylenediamine and 1,3-dimethylcyclobutane tetracarboxylic acid at a molar ratio of 50:50, and the polyimide PI-3 was prepared by adding 5 wt % of an additive thereto. The structure of the additive in Example 2 is shown below:

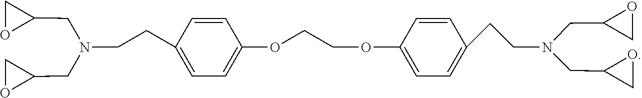 [SMILES: c1cc(OCCOc2ccc(CCN(CC3CO3)CC3CO3)cc2)ccc1CCN(CC1CO1)CC1CO1]

In Example 2, a polyimide was obtained by polymerization reaction of p-phenylenediamine and 1,3-dimethylcyclobutane tetracarboxylic acid at a molar ratio of 50:50, and the polyimide PI-4 was prepared by adding 5 wt % of an additive thereto. The structure of the additive in Example 2 is shown below:

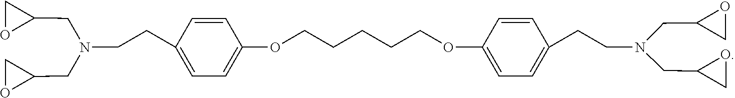 [SMILES: c1cc(OCCCCCOc2ccc(CCN(CC3CO3)CC3CO3)cc2)ccc1CCN(CC1CO1)CC1CO1]

In Example 3, a polyimide is obtained by polymerization reaction of p-phenylenediamine and 1,3-dimethylcyclobutane tetracarboxylic acid at a molar ratio of 50:50, and the polyimide PI-5 was prepared by adding 5 wt % of an additive thereto. The structure of the additive in Example 3 is shown below:

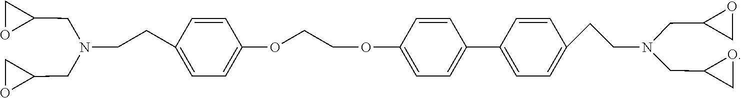 [SMILES: c1cc(OCCOc2ccc(-c3ccc(CCN(CC4CO4)CC4CO4)cc3)cc2)ccc1CCN(CC1CO1)CC1CO1]

Next, the prepared polyimides were each calcined into films and tested for mechanical hardness. Then, the electro-optic conversion liquid crystal box shown in FIG. 1 was further prepared and tested for its long-term AC drive-induced residual image using a long-time AC driving test to verify the enhancement of mechanical hardness by the addition of the additives in Examples 1, 2, and 3 and the improvement of the long-term AC drive-induced residual image (PI anchoring force).

During the mechanical hardness test, the calcined PI films are placed upward and fixed, and then are scratched firmly with a pencil at an angle of 45° relative to the test specimen without breaking the lead core. The films are scratched about 1 cm towards the front of the tester at a constant speed. The speed of scratching is 1 mm/s. After scratching once, the tip of the lead core should be reground, and the test is repeated five times with a pencil of the same hardness marking. When observing the breakage of the coating film for evaluation, if the substrate or the primed film is visible in only 2 or less out of the 5 tests, the same test should be performed with a pencil with a one-digit larger hardness mark, and when the coating is broken in more than 2 tests (for the 5 tests performed), the hardness mark of the pencil at that time may be read and the one-digit smaller hardness mark than the pencil's hardness mark may be noted down as the result of the test. The results are shown in Table I below.

TABLE I
Test data for the hardness

| | Monomer ratio | | Additive ratio | | | | Pencil |
|---|---|---|---|---|---|---|---|
| Polyimide | A (mol %) | B (mol %) | Z1 (wt %) | M1 (wt %) | M2 (wt %) | M3 (wt %) | hardness |
| PI-1 | 50 | 50 | 0 | 0 | 0 | 0 | 2H |
| PI-2 | 50 | 50 | 5 | 0 | 0 | 0 | 3H |
| PI-3 | 50 | 50 | 0 | 5 | 0 | 0 | 2H |
| PI-4 | 50 | 50 | 0 | 0 | 5 | 0 | 3H |
| PI-5 | 50 | 50 | 0 | 0 | 0 | 5 | 3-4H |

The substrate with electrodes is prepared during the long-term AC drive test. The substrate is a glass substrate with a size of 30 mm×35 mm and a thickness of 0.7 mm. On the glass substrate, the ITO electrodes having a faceted pattern are formed as the counter electrode of the first layer. On the counter electrode of the first layer, a SiN (silicon nitride) film is formed by a CVD (chemical vapor deposition) method as a second layer, and the SiN film as the second layer is has a thickness of 500 nm, and on the SiN film as the second layer, a pixel electrode formed by patterning the ITO film in the shape of a comb is configured as a third layer, and the area corresponding to the pixel electrode can be considered as a pixel such that a plurality of pixels, such as a first pixel and a second pixel, can be obtained. The dimensions of each pixel are 10 mm in length and about 5 mm in width.

At this time, the counter electrode of the first layer and the pixel electrode of the third layer are electrically insulated by the SiN film of the second layer. As shown in FIG. 7, the pixel electrode 411 of the third layer has a comb shape in a central portion curved at an inner angle of 1600 in which a plurality of electrode elements having a width of 3 μm are arranged in parallel at intervals of 6 μm, and one pixel has a first region 4111 and a second region 4112 bounded by a line connecting the curved portions of the plurality of electrode elements.

If the first region 4111 and the second region 4112 of each pixel are compared, the electrode elements constituting the respective pixel electrode are formed in different directions. In a case in which the rubbing direction of the liquid crystal alignment film as described later is taken as a reference, the electrode elements of the pixel electrode 411 are formed in a manner forming an angle of +10° (clockwise) in the first region 4111 of the pixel, and the electrode elements of the pixel electrodes 411 are formed in a manner forming an angle of −10° (clockwise) in the second region 4112 of the pixel. In the first region 4111 and the second region 4112 of each pixel, the rotational movement of the liquid crystals, sensed by the voltage applied between the pixel electrode 411 and the counter electrode, within the substrate surface is performed in a direction that is opposite to each other.

The above polyimides PI-1, PI-2, PI-3, PI-4, and PI-5 were each calcined into the uniform films of 100 nm on the above substrate and irradiated with linearly polarized UV light at a wavelength of 254 nm with an illumination intensity of 500 mJ/cm², and further baked, to obtain the substrates with the polyimide alignment layers. The two substrates with the polyimide alignment layers are used as a group, and a sealant is printed on the area of the substrate other than the liquid crystal injection port, and another substrate is laminated in such a way that the liquid crystal alignment films face opposite to each other and the friction direction becomes antiparallel. Then, the sealant was allowed to cure and the empty box with a box gap of 3.5 μm was produced. A negative type liquid crystal MLC 2767 (made by Merck) was injected into the empty box by the decompression injection method, and the injection port was sealed to obtain the liquid crystal box having the FFS mode.

Further, an AC (alternating current) voltage of ±6V was applied to the liquid crystal box fabricated as described above at a frequency of 60 Hz for 120 hours at a constant temperature of 60° C. Then, the liquid crystal box is placed directly at room temperature for one day after forming a short circuit between the pixel electrode and the counter electrode in the liquid crystal box. After placement, the liquid crystal box is set between two polarizers configured in a manner that the respective polarization axes are orthogonal to each other. Then, the backlight was lighted up in a state where no voltage is applied, and the angle of configuration of the liquid crystal box is adjusted in such a way that the luminance of the transmitted light is minimized. Then, the angle of rotation when the liquid crystal box is rotated from the angle at which the second region 4112 of the first pixel is darkest to the angle at which the first region 4111 of the first pixel is darkest is calculated as the angle A. Similarly, in the second pixel, the same angle A is calculated by comparing the second region 4112 with the first region 4111. and the results shown in Table II below are obtained.

TABLE II
Residual Image Data

| | Results for AC residual |
|---|---|
| Polyimide | image (Δ) |
| PI-1 | 1.33 |
| PI-2 | 1.62 |
| PI-3 | 0.92 |
| PI-4 | 1.05 |
| PI-5 | 0.78 |

As can be seen from the Table I above, by adding the additive to the alignment film composition, the hardness of the produced alignment layer can be effectively increased, and thus the probability that the alignment layer is scratched can be reduced; In addition, as can be seen from Table II, the additive provided by some embodiments of the present disclosure can also reduce the angle result for AC residual image (Δangle) on the basis of increasing the hardness of the alignment layer with respect to the comparative additive in the Comparative Example 2, and the smaller the angle result for AC residual image (Δangle) is, i.e., the smaller the difference between the result after the long-term AC drive operation and that of the initial state is, the stronger the anchoring force to the liquid crystals is. Therefore, as can be seen from Tables I and II, some embodiments of the present disclosure can effectively increase the hardness of the first alignment layer 21 and the second alignment layer 22, and can also effectively improve the anchoring force of the first alignment layer 21 and the second alignment layer 22 to the liquid crystals, which in turn can remedy the phenomenon of light leakage from the display panel.

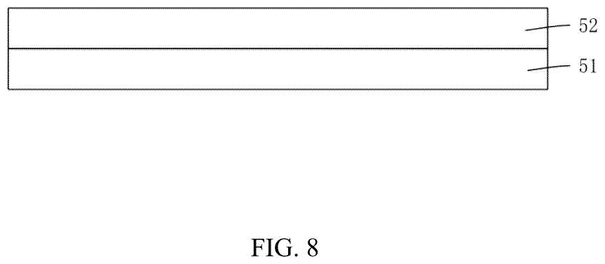

Further, referring to FIG. 8, some embodiments of the present disclosure also provide a display device. The display device comprises a display panel 51 described in the above embodiments and a backlight module 52. The display panel 51 is provided on the light exit side of the backlight module 52.

It will be appreciated that since the display device provided by some embodiments of the present disclosure has the same display panel as in the embodiments described above, the display device has the same beneficial effects as those in the embodiments described above, which will not be repeated herein.

A detailed description of the alignment film composition and the display panel provided by some embodiments of the present disclosure is provided above. While the specific examples are applied herein to illustrate the principles and implementations of the present disclosure, and the illustrations of the above embodiments are only used to aid in the understanding of the methods of the present disclosure and the core ideas thereof. Meanwhile, to those skilled in the art, based on the ideas of the present disclosure, there will be medications to the specific implementation and the scope of application. In summary, the contents of the present specification should not be construed as a limitation of the present disclosure.

What is claimed is:

1. A display panel, comprising:
a first substrate;
a second substrate, disposed opposite to the first substrate; and
a first alignment layer disposed on a side of the first substrate closer to the second substrate, wherein the first alignment layer has a first polyimide molecular chain, and the first polyimide molecular chain comprises a unit represented by formula 1 below: 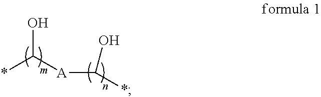
wherein A is a group comprising at least one of a phenoxy group or a biphenyl group, n is an integer greater than or equal to 1, and m is an integer greater than or equal to 1.

2. The display panel according to claim 1, wherein the first polyimide molecular chain comprises a unit represented by formula 2 below: 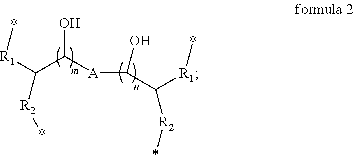
wherein R₁ is selected from a diamine subunit having a number of carbon atoms ranging from 1 to 50 and R₂ is selected from a dianhydride subunit having a number of carbon atoms ranging from 8 to 14.

3. The display panel according to claim 1, wherein the first polyimide molecular chain comprises a unit represented by formula 3 below: 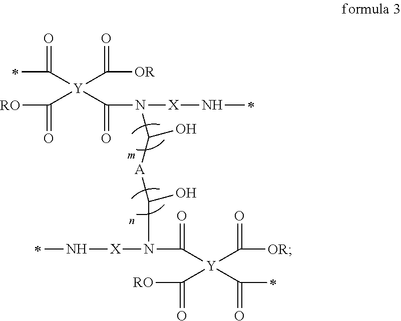
wherein X is selected from a substituted or unsubstituted aliphatic group having a number of carbon atoms ranging from 1 to 50 or a substituted or unsubstituted aromatic group having a number of carbon atoms from 6 to 50, Y is selected from a substituted or unsubstituted cycloalkyl group having a number of carbon atoms from 4 to 10, and R is selected from a hydrogen atom or a substituted or unsubstituted alkyl group having a number of carbon atoms ranging from 1 to 5.

4. The display panel according to the claim 1, wherein X is a phenyl group, Y is 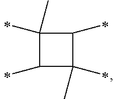
and R is a hydrogen atom.

5. The display panel according to claim 1, wherein m and n are each independently an integer less than or equal to 6.

6. The display panel according to claim 1, wherein the display panel further comprises a second alignment layer disposed on the side of the second substrate closer to the first substrate, wherein the second alignment layer has a second polyimide molecular chain and the second polyimide molecular chain comprises the unit represented by the formula 1.

7. The display panel according to claim 6, wherein A in the first polyimide molecular chain and A in the second polyimide molecular chain are each independently selected from at least one of a group having a phenoxy group or a group having a biphenyl group.

8. The display panel according to claim 4, wherein the display panel further comprises a liquid crystal layer disposed between the first alignment layer and the second alignment layer, the liquid crystal layer comprises liquid crystal molecules, and the liquid crystal molecules comprise at least one of the phenoxy group or the biphenyl group.

9. A display panel according to claim 8, wherein the liquid crystal molecules are selected from at least one of a group consisting of:

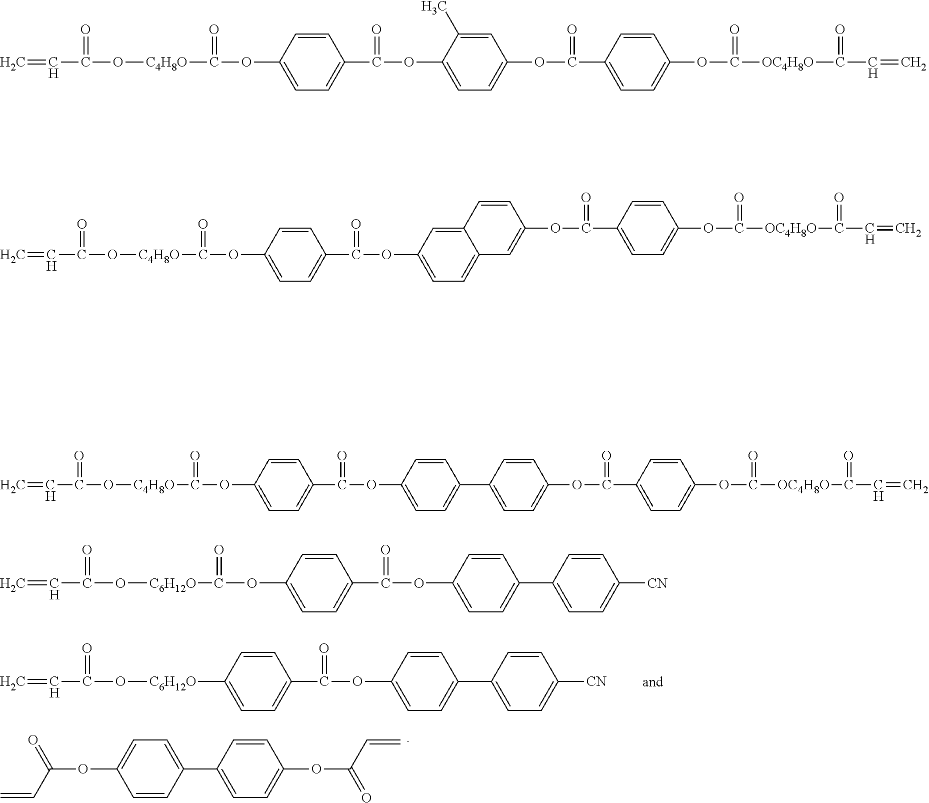

10. The display panel according to claim 8, further comprising a first electrode layer disposed on a first substrate, and a second electrode layer disposed on a second substrate, wherein the first alignment layer is disposed on a side of the first electrode layer closer to the second substrate, and the second alignment layer is disposed on a side of the second electrode layer closer to the first substrate.

11. The display panel according to claim 6, wherein the first alignment layer has a thickness of greater than or equal to 0.1 nm and less than or equal to 2 μm, and the second alignment layer has a thickness of greater than or equal to 0.1 nm and less than or equal to 2 μm.

12. The display panel according to claim 6, wherein A further comprises a group containing N and C.

13. The display panel according to claim 8, wherein the liquid crystal layer has a thickness greater than or equal to 0.1 μm and less than or equal to 100 μm.

14. The display panel according to claim 1, wherein the unit represented by the formula 1 is selected from at least one of a group consisting of:

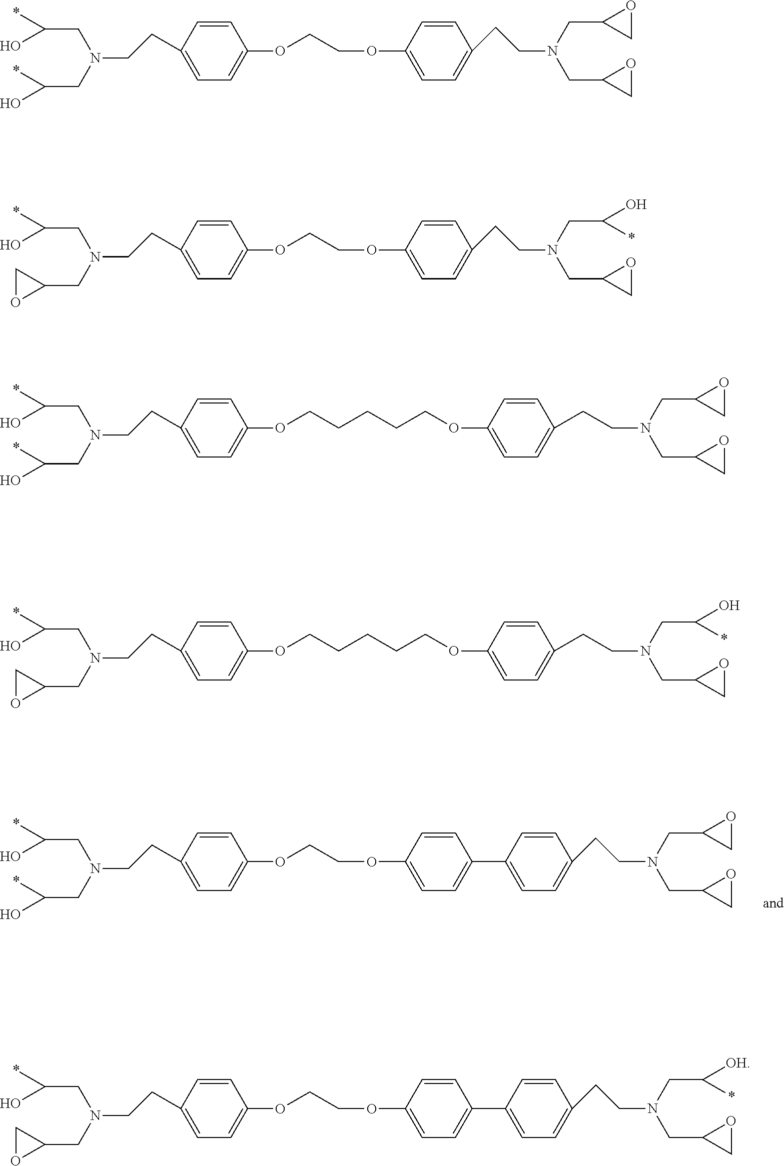

15. A alignment film composition, wherein the alignment film composition comprises a diamine monomer, a dianhydride monomer, and an additive, the additive has a structure represented by formula 4 below: 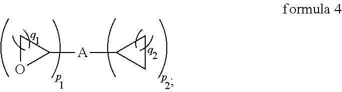
wherein A is a group comprising at least one of a phenoxy group or a biphenyl group, and p₁, p₂, q₁, and q₂ each are an integer greater than or equal to 1.

16. The alignment film composition according to claim 15, wherein p₁, p₂, q₁, and q₂ are each an integer less than or equal to 6.

17. The alignment film composition according to claim 15, wherein the additive is present in a content of greater than or equal to 0.1% and less than or equal to 20% by mass in the liquid crystal composition.

18. The alignment film composition according to claim 15, wherein the additive is selected from at least one of a group consisting of:

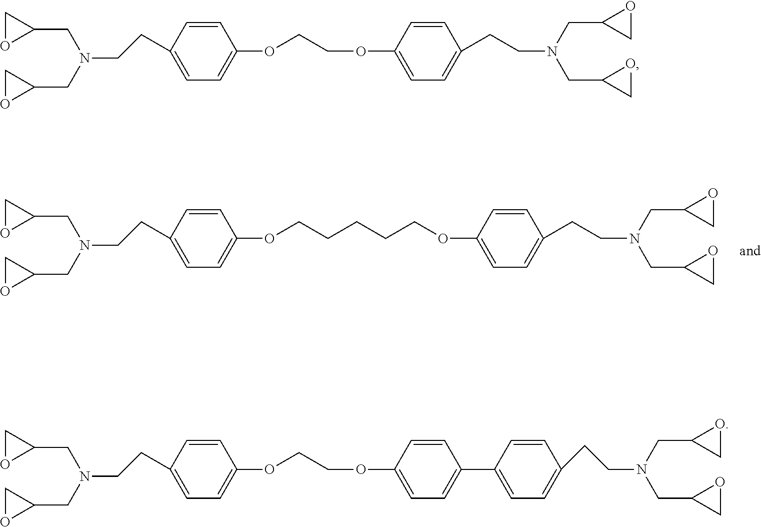 [SMILES: c1cc(OCCOc2ccc(CCN(CC3CO3)CC3CO3)cc2)ccc1CCN(CC1CO1)CC1CO1 ; c1cc(OCCCCCOc2ccc(CCN(CC3CO3)CC3CO3)cc2)ccc1CCN(CC1CO1)CC1CO1 ; "and" ; c1cc(OCCOc2ccc(-c3ccc(CCN(CC4CO4)CC4CO4)cc3)cc2)ccc1CCN(CC1CO1)CC1CO1]

19. The alignment film composition according to claim 15, wherein the diamine monomer has a number of carbon atoms ranging 1 to 50, and the dianhydride monomer has a number of carbon atoms ranging of 8 to 14.

20. A display device comprising a display panel and a backlight module, wherein the display panel is provided on a light exit side of the backlight module and comprises:
a first substrate;
a second substrate, disposed opposite to the first substrate; and
a first alignment layer disposed on a side of the first substrate closer to the second substrate, wherein the first alignment layer has a first polyimide molecular chain, and the first polyimide molecular chain comprises a unit represented by formula 1 below: 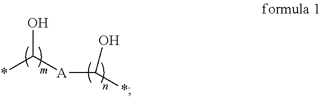
wherein A is a group comprising at least one of a phenoxy group or a biphenyl group, n is an integer greater than or equal to 1, and m is an integer greater than or equal to 1.
